(19) United States
(12) Patent Application Publication
(10) Pub. No.: US 2015/0062185 A1
(43) Pub. Date: Mar. 5, 2015

(54) ELECTRONIC APPARATUS AND METHOD FOR CONTROLLING BRIGHTNESS FOR A DISPLAY

(71) Applicant: HTC Corporation, Taoyuan County (TW)

(72) Inventors: Syuan-Ling Yang, Taoyuan County (TW); Tun-Chun Yang, Taoyuan County (TW); Chih-Jen Hu, Taoyuan County (TW)

(73) Assignee: HTC Corporation, Taoyuan County (TW)

(21) Appl. No.: 14/017,256

(22) Filed: Sep. 3, 2013

(51) Int. Cl. G09G 3/34

(52) U.S. Cl. CPC G09G 3/3406
USPC 345/690

(57) ABSTRACT

An electronic apparatus including a display, a light sensor and a controller is provided. The display displays an image. The light sensor measures the ambient brightness received by the display. The controller is coupled to the display and the light sensor. The hardware brightness range of the display is divided into a plurality of segments, wherein the first segment includes the hardware lowest brightness of the display and the last segment includes the hardware highest brightness of the display. The controller limits the display brightness of the display to one of the segments according to the ambient brightness. The controller allows the user of the electronic apparatus to set the display brightness only when the display brightness is limited to the first segment.

### BACKGROUND

1. Technical Field

The invention relates to an electronic apparatus and a method for controlling brightness for a display. Particularly, the invention relates to a method for controlling brightness for a display according to an ambient brightness.

2. Related Art

A mobile phone has a characteristic of portability which allows a user to carry it around, so that a usage environment of the mobile phone includes a dark indoor environment and a bright outdoor environment. In case of the outdoor environment, a display image of the mobile phone probably cannot be clearly viewed due to the bright ambient environment.

Generally, the user can adjust a brightness of the display through an interface of the mobile phone, though power consumption of high brightness display is far greater than that of general brightness display, and the usage environment of the mobile phone is not always bright. When the user sets the display to a high brightness under the bright environment, and enters a dark environment later, the high brightness of the display may cause unnecessary power consumption, which shortens a usage time of the mobile phone.

### SUMMARY

The invention is directed to an electronic apparatus and a method for controlling brightness for a display, by which image visibility and a power saving requirement of the electronic apparatus are both taken into consideration.

The invention provides an electronic apparatus including a display, a light sensor and a controller. The display displays an image. The light sensor measures an ambient brightness received by the display. The controller is coupled to the display and the light sensor. A hardware brightness range of the display is divided into a plurality of segments, where a first segment includes a hardware lowest brightness of the display, and a last segment includes a hardware highest brightness of the display. The controller limits a display brightness of the display to one of the segments according to the ambient brightness, and the controller allows a user of the electronic apparatus to set the display brightness only when the display brightness is limited to the first segment.

The invention provides a method for controlling brightness for a display, which is adapted to be executed by the aforementioned electronic apparatus, and the method includes following steps. An ambient brightness received by the display is measured, where a hardware brightness range of the display is divided into a plurality of segments, where a first segment includes a hardware lowest brightness of the display, and a last segment includes a hardware highest brightness of the display. A display brightness of the display is limited to one of the segments according to the ambient brightness, and a user of the electronic apparatus is allowed to set the display brightness only when the display brightness is limited to the first segment.

According to the above descriptions, according to the electronic apparatus and the method for controlling brightness of the display image, image visibility of the display is automatically improved in a high brightness environment, and the display brightness of the display is automatically decreased in a low brightness environment, so as to decrease the power consumption.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic apparatus according to an embodiment of the invention.

FIG. 2 is a flowchart illustrating a method for controlling brightness for a display according to an embodiment of the invention.

FIG. 3 is a schematic diagram of a hardware brightness range of a display according to an embodiment of the invention.

FIG. 4 is a schematic diagram of a hardware brightness range of a display according to another embodiment of the invention.

### DETAILED DESCRIPTION OF DISCLOSED EMBODIMENTS

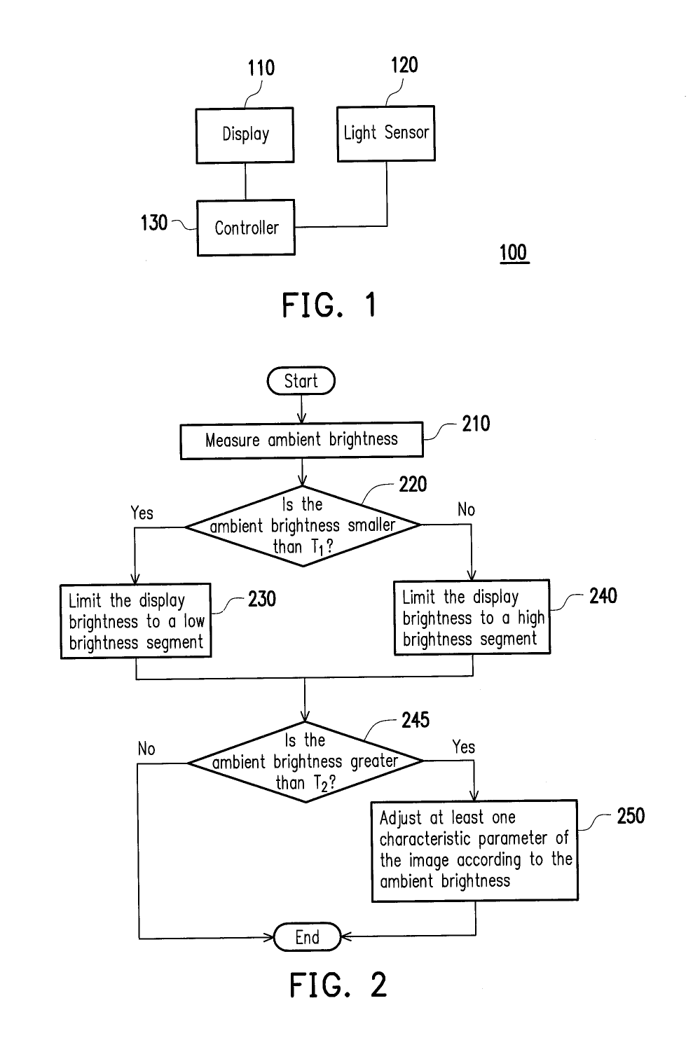

FIG. 1 is a schematic diagram of an electronic apparatus 100 according to an embodiment of the invention. The electronic apparatus 100 can be any electronic apparatus including a display, for example, a smart phone, a personal digital assistant (PDA), a digital camera, a tablet PC, a notebook computer, a desktop computer, a computer display, a television, etc. The electronic apparatus 100 includes a display 110, a light sensor 120 and a controller 130. The display 110 is configured to display an image. The light sensor 120 is configured to measure an ambient brightness V_{AB} received by the display 110. The controller 130 is coupled to the display 110 and the light sensor 120. The controller 130 may adjust a display brightness V_{D} of the display 110 according to the ambient brightness V_{AB}, and limit a range of the display brightness V_{D}.

FIG. 2 is a flowchart illustrating a method for controlling brightness for a display according to an embodiment of the invention. The method of FIG. 2 can be executed by the electronic apparatus 100. In step 210, the light sensor 120 measures the ambient brightness V_{AB} received by the display 110. In step 220, the controller 130 determines whether the ambient brightness V_{AB} is smaller than a predetermined value T₁. When the ambient brightness V_{AB} is smaller than the predetermined value T₁, in step 230, the controller 130 limits the display brightness V_{D} of the display 110 within a low brightness segment. When the ambient brightness V_{AB} is greater than or equal to the predetermined value T₁, in step 240, the controller limits the display brightness V_{D} of the display 110 within a high brightness segment.

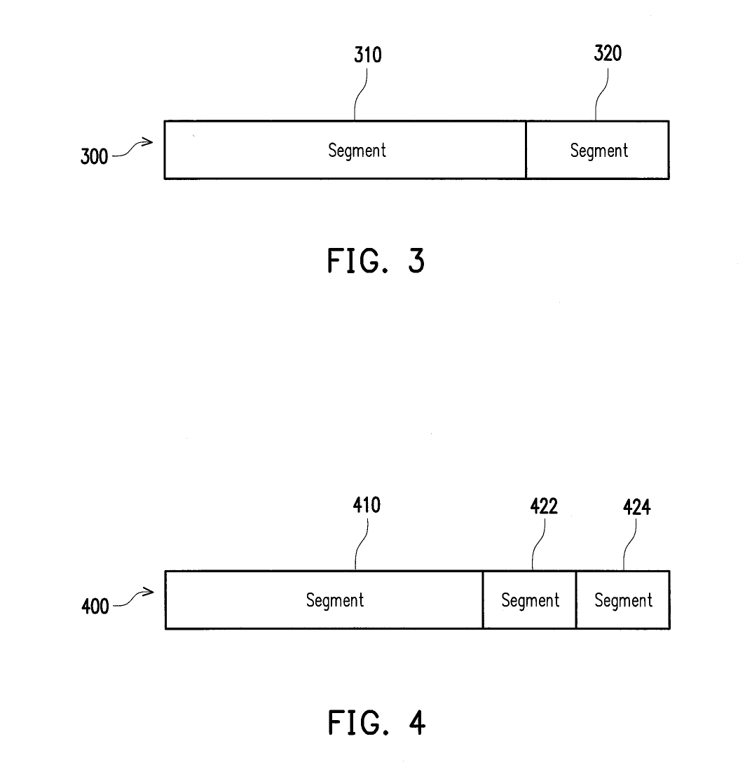

FIG. 3 and FIG. 4 illustrate two examples of the step S230 and the step 240. FIG. 3 is a schematic diagram of a hardware brightness range 300 of the display 110 according to an embodiment of the invention. The hardware brightness range 300 covers a lowest brightness and a highest brightness that can be reached by the hardware of the display. In the hardware brightness range 300, the left side represents lower brightness, and the right side represents higher brightness, so that the leftmost part of the hardware brightness range 300 is the hardware lowest brightness of the display 110, and the rightmost part of the hardware brightness range 300 is the hardware highest brightness of the display 110. As that shown in FIG. 3, the hardware brightness range 300 of the display 110 includes two segments 310 and 320. The segment 310 includes the hardware lowest brightness of the display 110, and the segment 320 includes the hardware highest brightness of the display 110. The brightness of the segment 320 is higher than that of the segment 310.

When the ambient brightness V_{AB} is smaller than the predetermined value T₁, the low brightness segment of the step 230 is the segment 310. In this case, the controller 130 allows the user of the electronic apparatus 100 to set the display brightness V_{D} of the display 110 in the segment 310, and the controller 130 limits the display brightness V_{D} within the segment 310. Namely, the user cannot set the display brightness V_{D} beyond the segment 310.

When the ambient brightness V_{AB} is greater than or equal to the predetermined value T₁, the high brightness segment of the step 240 is the segment 320. In this case, the controller 130 limits the display brightness V_{D} within the segment 320, and the controller 130 does not allow the user of the electronic apparatus 100 to set the display brightness V_{D} of the display 110. The controller 130 can set the display brightness V_{D} in the segment 320 according to the ambient brightness V_{AB}, and the display brightness V_{D} is directly proportional to the ambient brightness V_{AB}.

In overall, when the ambient brightness V_{AB} is relatively low, the user can arbitrarily set the display brightness V_{D} in the segment 310, though the user cannot set the display brightness V_{D} to the segment 320 with higher brightness. Now, the display brightness V_{D} set by the user cannot reach the hardware highest brightness of the display 110. When the ambient brightness V_{AB} is relatively high, the controller 130 releases the segment 320 with higher brightness. Now, the user is not allowed to set the display brightness V_{D}, and the controller 130 automatically sets the display brightness V_{D} according to the ambient brightness V_{AB}. Now, the display brightness V_{D} may the hardware highest brightness of the display 110.

FIG. 4 is a schematic diagram of a hardware brightness range 400 of the display 110 according to another embodiment of the invention. In the hardware brightness range 400, the left side represents lower brightness, and the right side represents higher brightness, so that the leftmost part of the hardware brightness range 400 is the hardware lowest brightness of the display 110, and the rightmost part of the hardware brightness range 400 is the hardware highest brightness of the display 110. The hardware brightness range 400 includes three segments 410, 422 and 424. The segment 410 includes the hardware lowest brightness of the display 110, and the segment 424 includes the hardware highest brightness of the display 110. The brightness of the segment 422 is higher than that of the segment 410. The brightness of the segment 424 is higher than that of the segment 422.

When the ambient brightness V_{AB} is smaller than the predetermined value T₁, the low brightness segment of the step 230 is the segment 410. In this case, the controller 130 allows the user of the electronic apparatus 100 to set the display brightness V_{D} of the display 110 in the segment 410, and the controller 130 limits the display brightness V_{D} within the segment 410. Namely, the user cannot set the display brightness V_{D} beyond the segment 410.

When the ambient brightness V_{AB} is greater than or equal to the predetermined value T₁ and is smaller than another predetermined value T_{1.1}, the high brightness segment of the step 240 is the segment 422. In this case, the controller 130 limits the display brightness V_{D} within the segment 422, and the controller 130 does not allow the user of the electronic apparatus 100 to set the display brightness V_{D} of the display 110. The controller 130 can set the display brightness V_{D} in the segment 422 according to the ambient brightness V_{AB}, and the display brightness V_{D} is directly proportional to the ambient brightness V_{AB}.

When the ambient brightness V_{AB} is greater than the predetermined value T_{1.1}, the high brightness segment of the step 240 is the segment 424. In this case, the controller 130 limits the display brightness V_{D} within the segment 424, and the controller 130 does not allow the user of the electronic apparatus 100 to set the display brightness V_{D} of the display 110. The controller 130 can set the display brightness V_{D} in the segment 424 according to the ambient brightness V_{AB}, and the display brightness V_{D} is directly proportional to the ambient brightness V_{AB}.

In overall, when the ambient brightness V_{AB} is relatively low, the user can arbitrarily set the display brightness V_{D} in the segment 410, though the user cannot set the display brightness V_{D} to the segments 422 and 424 with higher brightness. Now, the display brightness V_{D} set by the user cannot reach the hardware highest brightness of the display 110. When the ambient brightness V_{AB} is relatively high, the controller 130 releases the segment 422 and/or the segment 424 with higher brightness. Now, the user is not allowed to set the display brightness V_{D}, and the controller 130 automatically sets the display brightness V_{D} according to the ambient brightness V_{AB}. Now, the display brightness V_{D} may the hardware highest brightness of the display 110. Namely, the controller 130 allows the user to set the display brightness V_{D} only when the display brightness V_{D} is limited to the segment 410, and the user is not allowed to set the display brightness V_{D}, when the display brightness V_{D} is in other segments.

In the embodiment of FIG. 3, there is only one high brightness segment 320, and in the embodiment of FIG. 4, there are two high brightness segments 422 and 424. The number of the high brightness segments is not limited by the invention, and in other embodiments, there can be more high brightness segments.

Referring back to FIG. 2, after the steps 230 and 240 are completed, in step 245, the controller 130 determines whether the ambient brightness V_{AB} is greater than another predetermined value T₂. If the ambient brightness V_{AB} is smaller than or equal to the predetermined value T₂, the method flow is ended. If the ambient brightness V_{AB} is greater than the predetermined value T₂, in step 250, the controller 130 adjusts at least one characteristic parameter of an image displayed by the display 110 according to the ambient brightness V_{AB}, so as to improve image visibility of the display 110. The at least one characteristic parameter may include one or more of brightness, contrast, saturation, clarity and sharpness of the aforementioned image. Each of the aforementioned characteristic parameters can be set to be directly proportional to the ambient brightness V_{AB}. Since the relationship between each characteristic parameter and the ambient brightness V_{AB} can be defined in advance, the controller 130 may obtain the value of each characteristic parameter according to the ambient brightness V_{AB} through calculation or a lookup table.

The predetermined value T₂ can be one of the predetermined values used for dividing the display brightness segments, or another independent predetermined value. For example, in the embodiment of FIG. 3, the predetermined value T₂ can be equal to the predetermined value T₁, or smaller than the predetermined value T₁, or greater than the predetermined value T₁.

Similarly, in the embodiment of FIG. 4, predetermined value T₂ can be equal to the predetermined value T₁ or T_{1.1}, or smaller than the predetermined value T₁ or between T₁ and T_{1.1}, or greater than the predetermined value T_{1,1}. If the predetermined value T₂ is set to T₁, adjustment of the at least one characteristic parameter is activated only when the display brightness V_{D} of the display 110 enters the segment 422. If the predetermined value T₂ is set to T_{1.1}, adjustment of the at least one characteristic parameter is activated only when the display brightness V_{D} of the display 110 enters the segment 424. If the predetermined value T₂ is set to be smaller than the predetermined value T₁, when the ambient brightness V_{AB} is increased, adjustment of the at least one characteristic parameter is first activated, and then the high brightness segment 422 or/and segment 424 is/are released. If the predetermined value T₂ is set to be between the predetermined values T₁ and T_{1.1}, when the ambient brightness V_{AB} is increased, the high brightness segment 422 is first released, and then adjustment of the at least one characteristic parameter is activated. If the predetermined value T₂ is set to be greater than the predetermined value T_{1.1}, when the ambient brightness V_{AB} is increased, the high brightness segment 422 is first released, and then the high brightness segment 424 is released, and then adjustment of the at least one characteristic parameter is activated.

In the method flow of FIG. 2, the controller 130 first executes the steps 210-240, and then executes the steps 245-250. Namely, the controller first determines the brightness segment to which the display brightness V_{D} is limited, and then determines whether to adjust the aforementioned at least one characteristic parameter. In another embodiment, an execution sequence of the steps 210-240 and the steps 245-250 can also be exchanged. Namely, the controller 130 may first determine whether or not to adjust the aforementioned at least one characteristic parameter, and then determines the brightness segment to which the display brightness V_{D} is limited. Alternatively, in another embodiment, the steps 245 and 250 can be omitted.

In summary, according to the electronic apparatus and the method for controlling brightness for the display, the brightness of the display can be automatically adjusted according to the ambient brightness. In the low brightness environment, an upper limit of the brightness of the display can be automatically limited to avoid the user excessively increasing the brightness of the display to cause unnecessary power consumption. In the high brightness environment, the higher brightness range of the display is automatically released, and the display brightness of the display is automatically increased. In addition, the characteristic parameters of the image can be automatically adjusted to improve image visibility of the display of the electronic apparatus. Therefore, in the invention, image visibility of the display of the electronic apparatus and the power saving requirement of the electronic apparatus can be both taken into consideration.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electronic apparatus, comprising:
a display, displaying an image;
a light sensor, measuring an ambient brightness received by the display; and
a controller, coupled to the display and the light sensor, wherein a hardware brightness range of the display is divided into a plurality of segments, a first segment in the plurality of segments comprises a hardware lowest brightness of the display, and a last segment in the plurality of segments comprises a hardware highest brightness of the display; the controller limits a display brightness of the display to one of the segments according to the ambient brightness, and the controller allows a user of the electronic apparatus to set the display brightness only when the display brightness is limited to the first segment.

2. The electronic apparatus as claimed in claim 1, wherein when the ambient brightness is smaller than a first predetermined value, the controller limits the display brightness to the first segment; and when the ambient brightness is greater than or equal to the first predetermined value, the controller limits the display brightness to one of the other segments and sets the display brightness such that the display brightness is directly proportional to the ambient brightness.

3. The electronic apparatus as claimed in claim 1, wherein the controller adjusts at least one characteristic parameter of the image according to the ambient brightness.

4. The electronic apparatus as claimed in claim 3, wherein the at least one characteristic parameter comprises at least one of brightness, contrast, saturation, clarity and sharpness of the image.

5. The electronic apparatus as claimed in claim 3, wherein each said characteristic parameter is directly proportional to the ambient brightness.

6. The electronic apparatus as claimed in claim 3, wherein the controller adjusts the at least one characteristic parameter according to the ambient brightness only when the ambient brightness is greater than a second predetermined value.

7. The electronic apparatus as claimed in claim 6, wherein the controller first determines the segment to which the display brightness is limited, and then determines whether to adjust the at least one characteristic parameter.

8. The electronic apparatus as claimed in claim 6, wherein the controller first determines whether to adjust the at least one characteristic parameter, and then determines the segment to which the display brightness is limited.

9. A method for controlling brightness for a display, adapted to be executed by an electronic apparatus, wherein the electronic apparatus comprises a display, and the display displays an image, the method for controlling brightness for the display comprising:
measuring an ambient brightness received by the display, wherein a hardware brightness range of the display is divided into a plurality of segments, a first segment of the plurality of segments comprises a hardware lowest brightness of the display, and a last segment of the plurality of segments comprises a hardware highest brightness of the display;
limiting a display brightness of the display to one of the segments according to the ambient brightness; and
allowing a user of the electronic apparatus to set the display brightness only when the display brightness is limited to the first segment.

10. The method for controlling brightness for the display as claimed in claim 9, further comprising:
limiting the display brightness to the first segment when the ambient brightness is smaller than a first predetermined value; and
limiting the display brightness to one of the other segments and setting the display brightness such that the display brightness is directly proportional to the ambient brightness when the ambient brightness is greater than or equal to the first predetermined value.

11. The method for controlling brightness for the display as claimed in claim 9, further comprising:
adjusting at least one characteristic parameter of the image according to the ambient brightness.

12. The method for controlling brightness for the display as claimed in claim 11, wherein the at least one characteristic parameter comprises at least one of brightness, contrast, saturation, clarity and sharpness of the image.

13. The method for controlling brightness for the display as claimed in claim 11, wherein each said characteristic parameter is directly proportional to the ambient brightness.

14. The method for controlling brightness for the display as claimed in claim 11, further comprising:
adjusting the at least one characteristic parameter according to the ambient brightness only when the ambient brightness is greater than a second predetermined value.

15. The method for controlling brightness for the display as claimed in claim 14, further comprising:
first determining the segment to which the display brightness is limited, and then determining whether to adjust the at least one characteristic parameter.

16. The method for controlling brightness for the display as claimed in claim 14, further comprising:
first determining whether to adjust the at least one characteristic parameter, and then determining the segment to which the display brightness is limited.
